(19) United States
(12) Patent Application Publication
(10) Pub. No.: US 2015/0097514 A1
(43) Pub. Date: Apr. 9, 2015

(54) SMART MOBILE POWER DEVICE

(71) Applicant: Kun-Jung YANG, Taoyuan County (TW)

(72) Inventor: Kun-Jung YANG, Taoyuan County (TW)

(21) Appl. No.: 14/049,559

(22) Filed: Oct. 9, 2013

(51) Int. Cl. H02J 7/00

(52) U.S. Cl. CPC H02J 7/0054
USPC 320/103

(57) ABSTRACT

A smart mobile power device includes an input interface for electrically connecting an external power supply device; a charging circuit unit electrically connected with the input interface; a control unit electrically connected with the charging circuit unit; an electricity storage unit electrically connected with the charging circuit unit and the control unit; a discharging circuit unit electrically connected with the electricity storage unit and the control unit; and an output interface for electrically connecting a hand-held electronic device. A positive power cord, a negative power cord and at least one data transmission cable are connected between the output interface and the hand-held electronic device. The output interface is electrically connected with the discharging circuit unit. The present invention can be used for charge of an electronic product. The input interface and the output interface adopt the common configuration.

### BACKGROUND OF THE INVENTION

1. Field of the Invention

The present invention relates to a smart mobile power device, and more particular to a mobile power device which can adjust voltage and current automatically according the demand of input or output.

2. Description of the Prior Art

In these days, mobile electronic devices, such as smart phones, tablet PCs, game consoles, e-books, GPS navigation systems, notebooks and so on, are very popular. The mobile electronic device has a built-in battery to supply power. When the built-in battery has run down, it is necessary to use a charger for the built-in battery to be charged. The charger needs to connect with the mains supply. If the user goes out, it is unable to charge the mobile electronic device. Therefore, a mobile power source is developed. The mobile power source has a built-in battery to input and output electricity. The consumer can use the mobile power source to charge or output electricity for the mobile electronic device. However, the existing mobile power source adopts two different interfaces to input and output voltage. The consumer has to carry several cables in different configurations when going out. It is quite troublesome and inconvenient for use. Accordingly, the inventor of the present invention has devoted himself based on his many years of practical experiences to solve these problems.

### SUMMARY OF THE INVENTION

The primary object of the present invention is to provide a smart mobile power device to improve the shortcomings of the conventional mobile power device. The smart mobile power device has a common configuration interface, such that the user doesn't need to carry many cables to lighten its weight. It is convenient for use.

Another object of the present invention is to provide a smart mobile power device which can decide charging or discharging value and make an adjustment automatically, providing smart charging and discharging.

In order to achieve the aforesaid objects, the smart mobile power device of the present invention comprises an input interface, a charging circuit unit, a control unit, an electricity storage unit, a discharging circuit unit, and an output interface.

The input interface is an exposed insertion port of the smart mobile power device for electrically connecting an external power supply device. A positive power cord, a negative power cord, and at least one data transmission cable are connected between the input interface and the power supply device.

The charging circuit unit is electrically connected with the input interface. The charging circuit unit is further electrically connected with the control unit, the electricity storage unit and the discharging circuit unit.

The control unit is electrically connected with the charging circuit unit.

The electricity storage unit is electrically connected with the charging circuit unit and the control unit.

The discharging circuit unit is electrically connected with the electricity storage unit and the control unit.

The output interface is an exposed insertion port of the smart mobile power device for electrically connecting a hand-held electronic device. A positive power cord, a negative power cord, and at least one data transmission cable are connected between the output interface and the hand-held electronic device. The output interface is electrically connected with the discharging circuit unit.

The data transmission cables are connected between the power supply device, the input interface, the control unit, the output interface and the hand-held electronic device.

The control unit decides charging or discharging value and makes an adjustment automatically according to corresponding information.

The smart mobile power device further comprises a power switch.

The input interface and the output interface are a common configuration, namely, an input and output interface.

The advantages of the present invention are as follows:

The input and the output of the smart mobile power device of the present invention adopt a common interface. The input interface and the output interface may be a common configuration, namely, an input and output interface, such that the user doesn't need to carry many cables to lighten its weight. It is convenient for use.

The smart mobile power device comprises an input interface, an output interface and a control unit. The input interface and the output interface are respectively provided with data transmission cables connected to the control unit. The control unit decides charging or discharging value and makes an adjustment automatically according to corresponding information, providing smart charging and discharging.

### BRIEF DESCRIPTION OF THE DRAWINGS

FIG. 1 is a diagram according to a preferred embodiment of the present invention;

FIG. 2 is a diagram according to the preferred embodiment of the present invention when charging;

FIG. 3 is a diagram according to the preferred embodiment of the present invention when discharging;

FIG. 4 is a schematic view according to the preferred embodiment of the present invention when in use; and

FIG. 5 is a schematic view according to another embodiment of the present invention.

### DETAILED DESCRIPTION OF THE PREFERRED EMBODIMENTS

Embodiments of the present invention will now be described, by way of example only, with reference to the accompanying drawings.

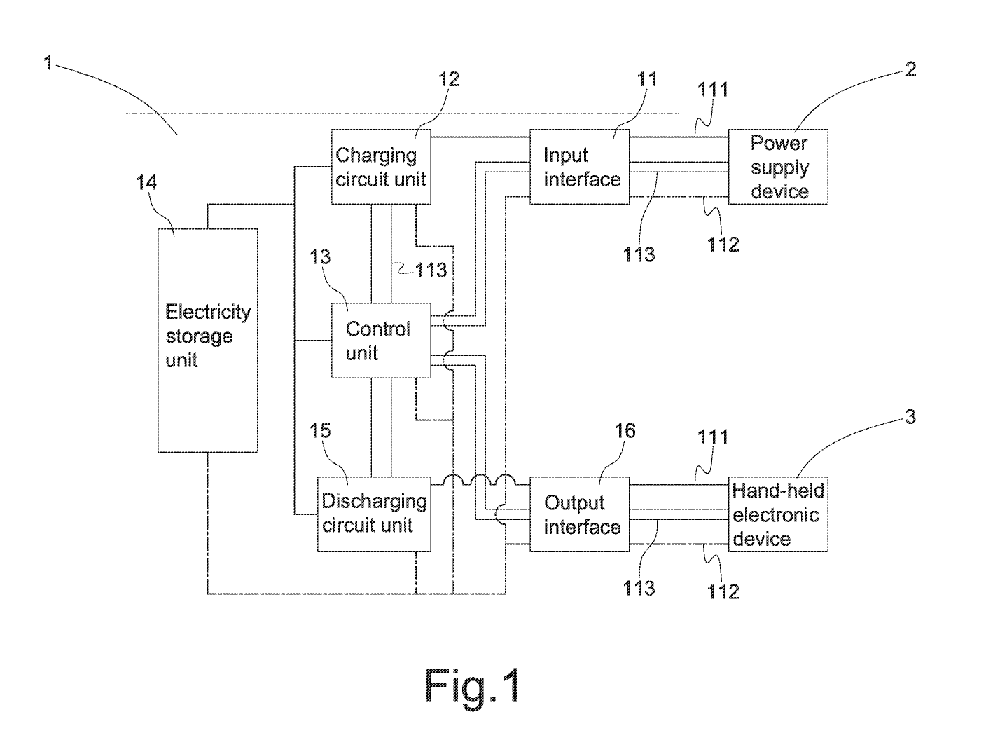

As shown in FIG. 1, the smart mobile power device 1 according to a preferred embodiment of the present invention comprises an input interface 11, a charging circuit unit 12, a control unit 13, an electricity storage unit 14, a discharging circuit unit 15, and an output interface 16.

The input interface 11 is an exposed insertion port of the smart mobile power device 1 for electrically connecting an external power supply device 2. A positive power cord 111, a negative power cord 112, and at least one data transmission cable 113 are connected between the input interface 11 and the power supply device 2.

The charging circuit unit 12 is electrically connected with the input interface 11. The charging circuit unit 12 is further electrically connected with the control unit 13, the electricity storage unit 14 and the discharging circuit unit 15. The charging circuit unit 12 can use the electricity storage unit 14 to charge. The control unit 12 has a control function. The electricity storage unit 14 provides an electricity storage function. The discharging circuit unit 15 is adapted to discharge the electricity of the electricity storage unit 14.

The output interface 16 is an exposed insertion port of the smart mobile power device 1 for electrically connecting a hand-held electronic device 3. A positive power cord 111, a negative power cord 112, and at least one data transmission cable 113 are connected between the output interface 16 and the hand-held electronic device 3. The output interface 16 is electrically connected with the discharging circuit unit 15.

The data transmission cables 113 are connected between the power supply device 2, the input interface 11, the control unit 13, the output interface 16 and the hand-held electronic device 3.

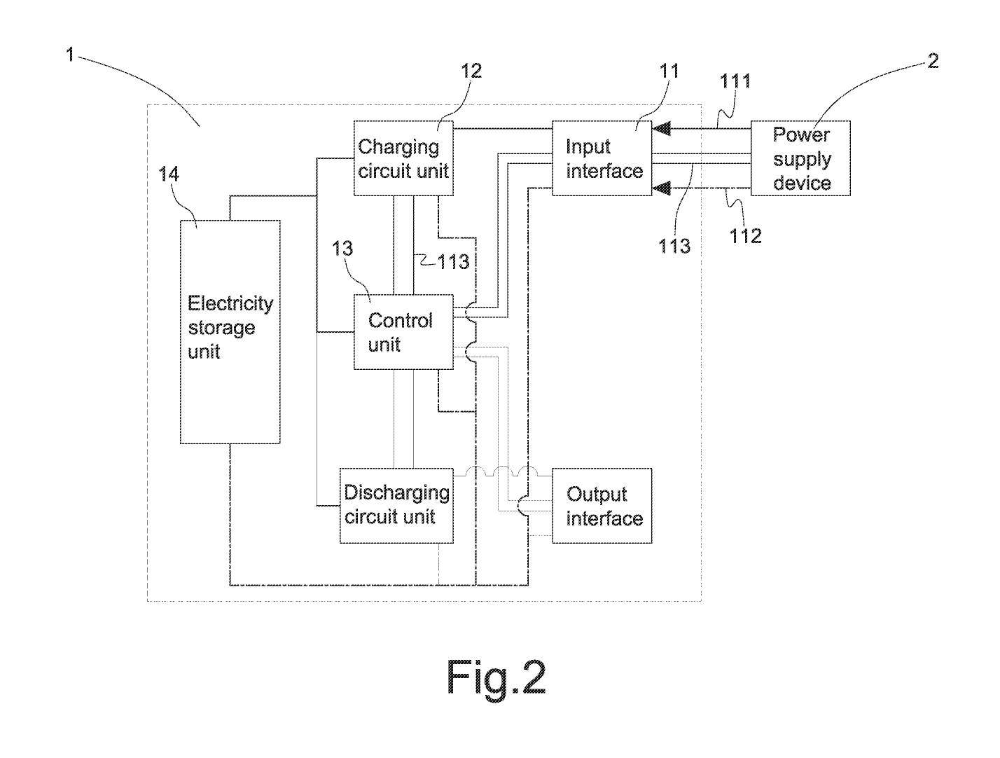

As shown in FIG. 2, when the present invention proceeds to charge, the power supply device 2 is electrically connected with the input interface 11. By using the data transmission cables 113, the control unit 13 decides the charging value and makes an adjustment automatically according to corresponding information to obtain the best operation state.

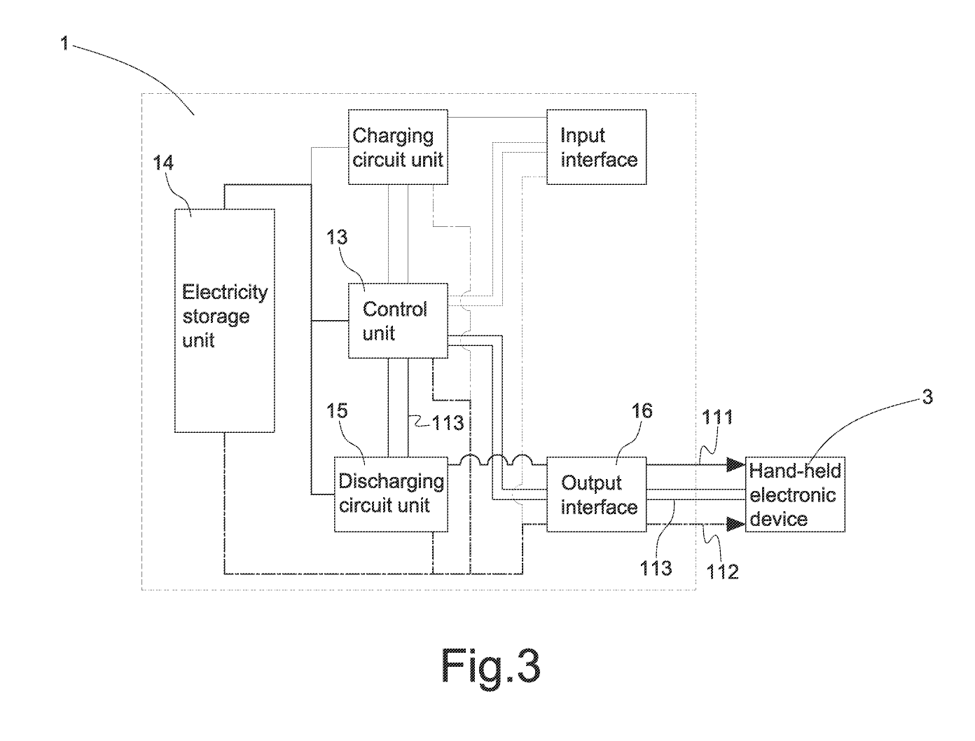

As shown in FIG. 3, when the present invention proceeds to discharge, the hand-held electronic device 3 is electrically connected with the output interface 16. By using the data transmission cables 113, the control unit 13 decides the discharging value and makes an adjustment automatically according to the corresponding information to obtain the best operation state.

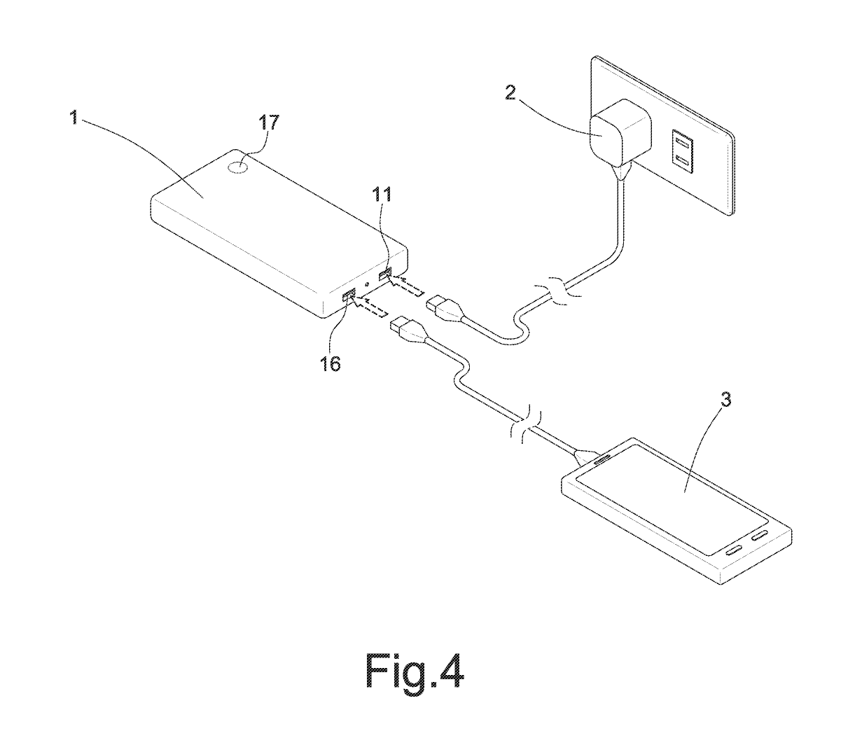

FIG. 4 is a schematic view showing the preferred embodiment of the present invention when in use. The outside of the smart mobile power device 1 is provided with a power switch 17 to switch on/off the smart mobile power device 1.

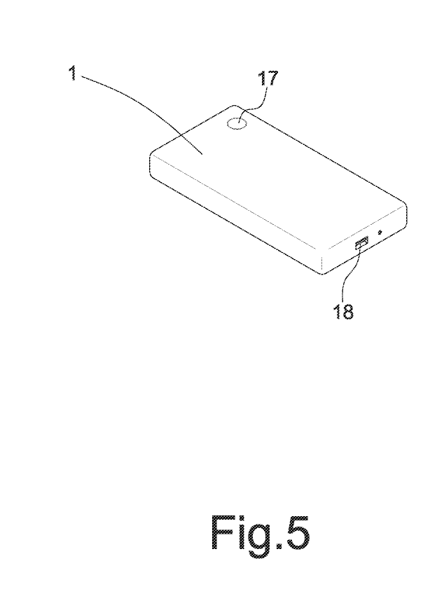

In this embodiment, the input interface 11 and the output interface 16 may be a common configuration, namely, the smart mobile power device 1 is provided with an input and output interface 18, as shown in FIG. 5.

In virtue of the existing technique, the power cord can be used to transmit data. Therefore, the data transmission cables of the present invention can share the positive power cord and the negative power cord.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A smart mobile power device, comprising:
an input interface, the input interface being an exposed insertion port of the smart mobile power device for electrically connecting an external power supply device;
a charging circuit unit, the charging circuit unit being electrically connected with the input interface;
a control unit, the control unit being electrically connected with the charging circuit unit;
an electricity storage unit, the electricity storage unit being electrically connected with the charging circuit unit and the control unit;
a discharging circuit unit, the discharging circuit unit being electrically connected with the electricity storage unit and the control unit; and
an output interface, the output interface being an exposed insertion port of the smart mobile power device for electrically connecting a hand-held electronic device, a positive power cord, a negative power cord and at least one data transmission cable being connected between the output interface and the hand-held electronic device, the output interface being electrically connected with the discharging circuit unit.

2. The smart mobile power device as claimed in claim 1, wherein the at least one data transmission cable is connected between the power supply device, the input interface, the control unit, the output interface and the hand-held electronic device.

3. The smart mobile power device as claimed in claim 1, wherein the control unit decides charging or discharging value and makes an adjustment automatically according to corresponding information.

4. The smart mobile power device as claimed in claim 1, further comprising a power switch.

5. The smart mobile power device as claimed in claim 1, wherein a positive power cord, a negative power cord and at least one data transmission cable are connected between the input interface and the power supply device.
